(19) United States
(12) Patent Application Publication
(10) Pub. No.: US 2011/0167108 A1
(43) Pub. Date: Jul. 7, 2011

(54) WEB PAGE TAMPER-FROOF DEVICE, METHOD AND SYSTEM

(76) Inventors: Xueli Chen, Beijing (CN); Dunqiu Fan, Beijing (CN)

(21) Appl. No.: 13/003,302

(22) PCT Filed: Jul. 9, 2009
(86) PCT No.: PCT/CN2009/000780

§ 371 Date: Feb. 4, 2011

(30) Foreign Application Priority Data
Jul. 11, 2008 (CN) 200810116571.6
Jul. 9, 2009 (CN) PCT/CN2009/00780

(51) Int. Cl. G06F 15/16

(52) U.S. Cl. 709/203

(57) ABSTRACT

The present invention discloses a web page tamper-proof device, wherein in the web page tamper-proof device, a network data packet processing unit intercepts network data packets returned from a network server, a web page regenerating unit receives the network data packets intercepted by the network data packet processing unit and regenerates content of a web page from the network data packets, a web page content comparison unit compares the content of web page regenerated by the web page regenerating unit with a previous backup content of the web page corresponding to the regenerated content of the web page to determine whether the regenerated content of the web page has been tampered and sends a message regarding the web page has been tampered to a network server take-over unit when the regenerated content of the web page is determined to have been tampered, and the network server take-over unit returns the backup content of the web page corresponding to the regenerated content of the web page back to the external network user upon receipt of the said message. The present invention further provides a method for use in the web page tamper-proof device and a system using the web page tamper-proof device.

### CROSS-REFERENCE TO RELATED APPLICATION

This application is a national phase filing of PCT Patent Application Number PCT/CN2009/000780, filed Jul. 9, 2009, which claims the priority benefit of Chinese Patent Application Number 200810116571.6, filed Jul. 11, 2008, which hereby incorporated herein by reference.

### TECHNICAL FIELD

The present invention relates to the field of network server security, in particular, to a device, method and system for preventing a web page of a network server from being tampered.

### BACKGROUND ART

With the advent of the information age, network servers that provide various kinds of web page related content information service through the network become more and more popular. For many reasons, e.g., vulnerabilities of the operation system used by the network server per se or wrong settings made by the network administrator of the network server, hackers can modify content of the web page provided by the network server without being authorized, where the content of the web page is modified to contain content of improper information so that users browsing the web page of the network server acquire wrong information, which brings considerable damage to the owner of the network server and the content provider.

In response, many methods are put forth to prevent the content of web pages on a network server from being tampered. Among all these methods, one of them is to install special software in the network server to achieve real-time monitoring of the content of the web page files. When the content of the web page is found to be tampered, a backup file of the web page is directly adopted to overwrite the tampered web page file. In this method, the comparison of Hash value (which is also called watermark) is usually used to determine whether the web page has been tampered.

However, the above mentioned method of preventing the content of web pages from being tampered has several disadvantages. Firstly, it needs to install special software in the network server, if the software itself has security problems, it will bring potential security problems to the network server. Secondly, as the software is operated on the network server, if the right of the network server acquired by hacker is high enough, the hacker may probably have the right to disable the software, and as a result, the software will become completely useless. Thirdly, as the software has to coordinate with applications that provide web page service on the network server (e.g., HTTP servers, etc.), the administrator of the network server has to change his work flow, which increases the workload of the network administrator. Besides, since the web page tamper-proof software simply overwrites the tampered web page file rather than directly takes measures to find out the reasons why the web page being tampered, the hacker who has intruded into the network server may modify the web page again, which will bring instability to the network server.

FIG. 1 shows a diagram 100 of a typical web page based information service providing system, where a plurality of network servers 101-103 are provided behind a gateway 201. A plurality of clients 401-403 connected with an external network 301 access the plurality of network servers 101-103 via the gateway 201 respectively. In the prior art, in order to prevent content of web pages on the network servers 101-103 from being tampered, it is necessary to install respectively special web page tamper-proof software in each of the network servers 101-103, and this will increase the workload of the administrator of the network server.

Moreover, the prior art cannot solve the problem of tampering the content of web page using ARP spoofing existed in the system as shown in FIG. 1. The principle of ARP spoofing is as follows: assuming that the network server 103 has been illegally intruded into by a hacker and the hacker has acquired sufficient right. After that, the hacker can transmit an ARP response initiatively to the gateway 201 from the network server 103, so as to bind the IP address of the network server 102 with the MAC address of the network server 103, such that when the clients 401-403 request the content of web pages of the network server 102 via the gateway 201, the request will be wrongly transmitted to the network server 103 which has been intruded into by the hacker for processing, and as a result, the clients 401-403 can only acquire content provided by the network server 103 rather than the network server 102. Viewed from the perspective of the clients 401-403, the content of web pages provided by the network server 102 has been tampered. It can be seen that when the content of web pages is tampered using ARP spoofing, even if the network server 102 has special web page tamper-proof software installed and the network server 102 has not been intruded into illegally, it cannot be guaranteed that the clients can acquire web page provided by the network server 102 which has not been tampered. That is, the prior art cannot solve the problem of web page tampering using ARP spoofing.

It can be seen from above that many problems arise for the current web page tamper-proof methods which need to install special software in the network server. Therefore, the present invention seeks to avoid these problems by providing a new web page tamper-proof device, method and system.

### SUMMARY OF THE INVENTION

According one aspect of the present invention, a web page tamper-proof method is provided, comprising the following steps: receiving a request for content of a web page of a network server from an external network user; acquiring network data packets returned by said network server in response to the request for the content of the web page from the external network user; regenerating the content of the web page based on the acquired network data packets; comparing the regenerated content of the web page with a previous backup content of the web page corresponding to the regenerated content of the web page, to determine whether the regenerated content of the web page has been tampered; and if the regenerated content of the web page has been tampered, feeding the backup content of the web page content back to the external network user.

According to a further aspect of the present invention, a web page tamper-proof device is provided, comprising: an external network interface, connected with a external network for receiving a request for content of a web page of a network server from a external network user and returning the requested content of the web page to the external network user; an internal network interface, connected with the network server for forwarding the request for the content of the web page from the external network user to the networker server and receiving network data packets returned by said network server in response to the request for the content of the web page; a network data packet processing unit, configured to intercept the network data packets returned by said network server in response to the request for the content of the web page; a web page regenerating unit, configured to receive the network data packets intercepted by the network data packet processing unit and regenerate the content of the web page from the network data packets; a web page content comparison unit, configured to compare the content of the web page regenerated by the web page recovering unit with the previous backup content of the web page corresponding to the regenerated content of the web page so as to determine whether the regenerated content of the web page has been tampered, and when the regenerated content of the web page is determined to have been tampered, send a message regarding the web page has been tampered to a network server take-over unit; and the network server take-over unit, configured to return the previous backup content of the web page corresponding to the regenerated content of the web page back to the external network user upon receipt of the message regarding the web page has been tampered.

According to a further aspect of the present invention, a web page tamper-proof system is provided, comprising: one or more network servers, which are provided with web page content; an external network, where user of the external network sends a request for content of a web page to one or more network servers for acquiring the web page content; and a web page tamper-proof device according to the present invention, connected between the one or more network servers and the external network, for returning the web page content by itself to the user of the external network when the web page content returned by the one or more network server has been tampered.

Since the present invention prevents the web page from being tampered by providing a device outside of the networker server, no software or middleware is required to be installed in the network server according to the present invention, which avoids security problems brought by the software or middleware per se. In addition, as the system according to the present invention provides a web page tamper-proof device located before the one or more network server, it is not necessary to change the work flow of the server administrator, and the problem of web page being tampered resulting from ARP spoofing can also be solved. Furthermore, as the web page tamper-proof device according to the present invention timely takes over the network server upon detection that the web page content of the network server has been tampered, the network server can be prevented from being tampered again and the scene of being tampered can be preserved for the administrator of the network server to find out the vulnerabilities of the network server and the source of the attach. These advantages are not seen in the web page tamper-proof methods in the prior art.

### DESCRIPTION OF THE FIGURES

Other advantages and benefits of the present invention will be clearly and obviously to those skilled in the art from the detailed description of the embodiments in the following text. The drawings are only used for the purpose of showing the embodiments and should not be construed as limiting the invention. The same reference signs represent the same components throughout the drawings, in which:

FIG. 1 illustrates a diagram of a web page based information service providing system 100 commonly seen in the prior art;

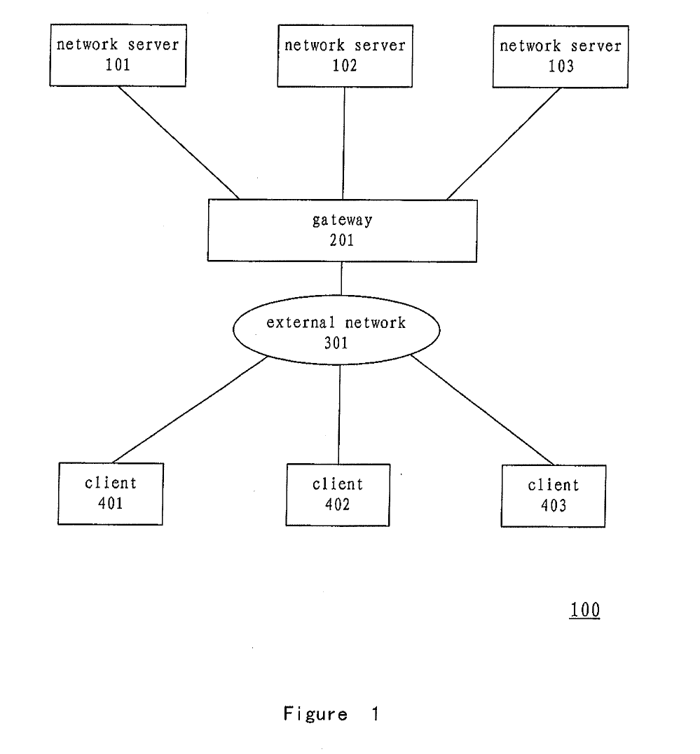

FIG. 2 illustrates a web page tamper-proof system 200 according to an embodiment of the present invention;

FIG. 3 illustrates a specific structure of a web page tamper-proof device 202 according to an embodiment of the present invention;

FIG. 4 illustrates a flowchart of a web page tamper-proof method 400 according to an embodiment of the present invention;

FIG. 5 illustrates a specific operation state of the web page tamper-proof system 200 according to an embodiment of the present invention; and

FIGS. 6A-6C illustrate a further specific operation state of the web page tamper-proof system 200 according to an embodiment of the present invention.

### DETAILED DESCRIPTION OF EMBODIMENTS

Further descriptions of the present invention are given as follows in combination with the figures and the embodiments.

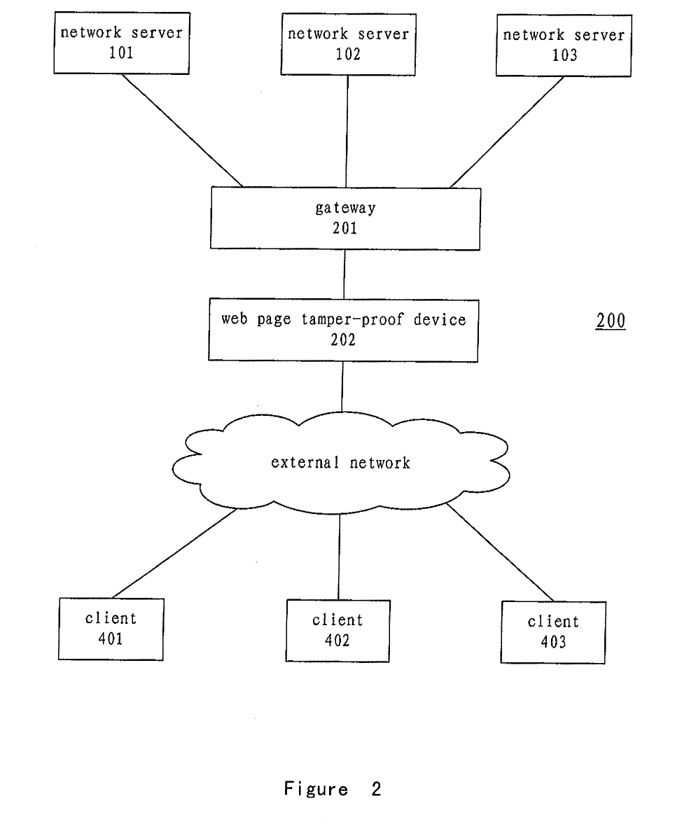

FIG. 2 shows a web page tamper-proof system 200 according to an embodiment of the present invention. It differs from the web page based information service providing system 100 commonly seen in the prior art in that, the web page tamper-proof system 200 further comprises a web page tamper-proof device 202. In FIG. 2, it has been shown that the web page tamper-proof device 202 is connected between a gateway 201 and an external network. However, it should be understood clearly that as long as all requests for web page of the network servers 101-103 pass through the web page tamper-proof device 202, the connection sequence of the device 202 and the gateway 201 can be of any sequence, and the device 202 and the gateway 201 can even be integrated into one component or the device can be connected between the gateway 201 and each one of the network servers 101-103. The web page tamper-proof device 202 is an individual hardware device, where all network data packets sent from clients 401-403 to the network servers 101-103 and/or sent from the network servers 101-103 to the clients 401-403 must pass through the web page tamper-proof device 202. Therefore, the web page tamper-proof function according to the present invention can be mainly implemented in the web page tamper-proof device 202.

The web page tamper-proof device 202 generally comprises at least two network interfaces, one of them is connected with an external network 301 for receiving a request for access to the network servers 101-103 from external network users such as the clients 401-403 and returning the web page content requested by the clients 401-403; the other network interface is connected with the gateway 201 or the network servers 101-103 for forwarding the request for access from the clients 401-403 to the network servers 101-103 and receiving the web page content returned from the network server 101-103.

The web page tamper-proof device 202 can be connected in an implicit manner between the external network 301 and the gateway 201. The so-called implicit manner means that the web page tamper-proof device 202 can be connected therebetween in a manner that is unknown to the external network user, and such connection manner includes the web page tamper-proof device 202 being operated in a promiscuous mode or in a firewall mode of a second layer in the TCP/IP protocol stack, etc. Of course, the web page tamper-proof device 202 can also be connected in an explicit manner, for instance, in a firewall mode of a third layer in the TCP/IP protocol stack, etc. where the clients are enabled to access the network servers 101-103 through a third layer firewall by properly settings such as DNAT and so on. However, no matter in an explicit manner or in an implicit manner, as long as the web page tamper-proof device 202 can intercept the information transmission between all the clients and the network servers, both manners are within the protection scope of the present invention.

The web page tamper-proof system 200 is operated as follows: firstly, a backup of the content of web pages of the network servers 101-103 is stored in advance in the web page tamper-proof device 202. Then, when a certain client 401 initiates a request for the web page content of one of the network servers 101-103 (for instance, network server 101 in the present embodiment), the web page content returned from the network server 101 passes through the web page tamper-proof device 202. The device 202 can regenerate the web page content returned from the network server 101, and compare the regenerated web page content with the web page content stored in advance in the device 202. If the device 202 determines that the web page content has not been tampered, then the web page content will be normally forwarded to the client 401; if the device 202 determines that the web page has been tampered, it can provide the backup web page content of the network server 101 stored therein to the client 401, and it can further cut off the connection between the external network 301 and the network server 101 and temporarily provide the web page content instead.

Since the web page tamper-proof device 202 is a special network device which usually has a relatively higher security level, and the web page tamper-proof device 202 is generally connected between the external network 301 and the gateway 201 in an implicit manner, it is difficult for the hackers to know the detail information of the web page tamper-proof device 202. Therefore, compared with the network servers 101-103, the web page tamper-proof device 202 is hard to be cracked by the hackers, so the web page content provided by the web page tamper-proof device 202 is hard to be tampered.

Furthermore, after the connection between the network server 101 and the external network has been cut off, professional computer administrator may analyze the current state (which is usually called “scene”) of the network server which has been attacked and the web page content of which has been modified by the hacker, to find out and patch the vulnerabilities existing in the network server 101 and recover the original web page content, and then recover the connection between the network server 101 and the external network.

The web page tamper-proof device 202 can also send an alarm to the network administrator by means of cellphone message or email upon detection of the web page content of the network server 101 being tampered.

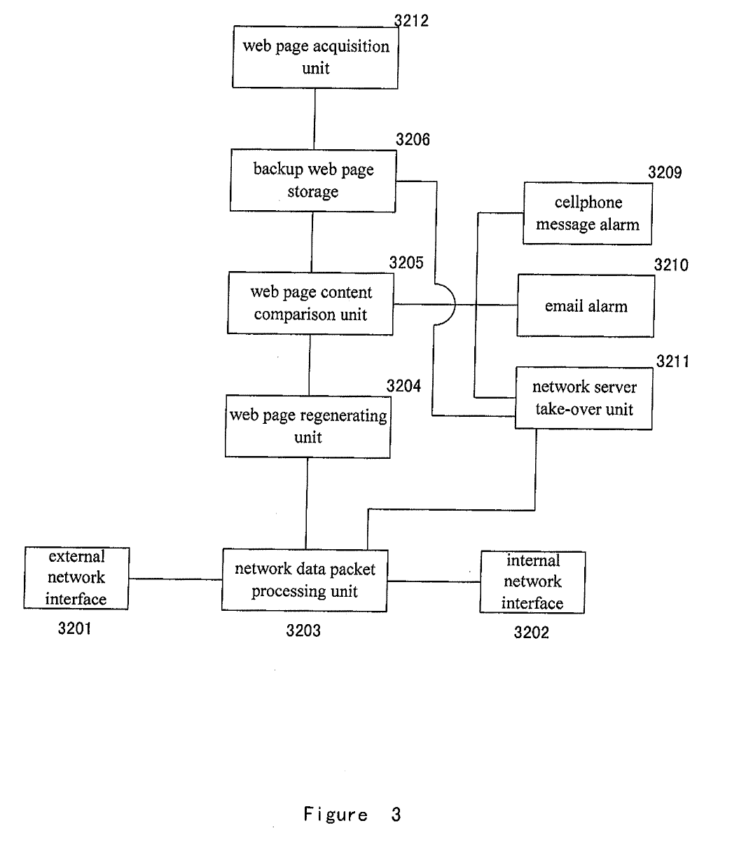

FIG. 3 shows the specific structure of the web page tamper-proof device 202 according to an embodiment of the present invention. The device 202 comprises an external network interface 3201 for connecting with the external network 301 and an internal network interface 3202 for connecting with the gateway 201 as aforementioned. The device 202 further comprises a network data packet processing unit 3203 configured to monitor the request for web page content by the external network user to the network servers 101-103 via the external network interface 3201, and intercept the network data packets returned from the network server 101-103 via the internal network interface 3202 which are then sent to a web page regenerating unit 3204 for processing. Generally speaking, for each request for web page content, there are correspondently more than one returned data packets, so the network data packet processing unit 3203 further comprises a storage unit for collecting network data packets corresponding to a certain request for web page content and sending them together to the web page regenerating unit 3204 for processing.

The web page regenerating unit 3204 regenerates the corresponding web page from the network data packets acquired and collected by the network data packet processing unit 3203 from the network servers 101-103. As the network servers 101-103 generally transmit data based on TCP/IP protocols, in order to regenerate the content data of the web page from the network data packets, the web page regenerating unit 3204 usually needs to perform the processing of IP decoding, TCP decoding and HTTP identification, etc. However, any other techniques for regenerating the content of a web page from the network data packets transmitted based on TCP/IP protocols are all within the protection scope of the present invention.

The web page regenerating unit 3204 transmits the regenerated web page content to a web page content comparison unit 3205. Since the regenerated web page content includes identifiers of the network server returning the web page content, such as IP address and port number of the network server, the web page content comparison unit 3205 can retrieve corresponding backup web page content from a backup web page storage 3206 based on the identifiers of the network server. The web page content comparison unit 3205 then compares it with the regenerated web page content to determine whether the regenerated web page content has been tampered.

A technique for rapidly comparing the backup web page with the regenarated web page is to respectively calculate the Hash values of the regenerated web page content and the corresponding backup web page content retrieved from the backup web page storage 3206, to determine the regenerated web page content has been tampered when these two Hash values are not same, and to determine the regenerated web page content has not been tampered when these two Hash values are the same. Besides, in order to accelerate the processing speed, the Hash value of the backup web page content can be calculated in advance and stored in the backup web page storage 3206, and the web page content comparison unit 3205 can retrieve the Hash value of the backup web page content from the backup web page storage 3206 instead of the backup web page content itself. However, one skilled in the art should clearly understand that the techniques of comparing two web page contents to determine whether they are the same are not limited to the technique of Hash value comparison, and any techniques that can determine whether these two web page contents are the same are within the protection scope of the present invention.

As recited above, the backup web page storage 3206 stores the backup content of web pages consistent with the content of web pages of the network servers 101-103, and alternatively, the backup web page storage 3206 can further store the Hash value of the backup content of web pages. The backup web page storage 3206 can acquire the web page content provided by the network servers 101-103 by all means, which for instance, including directly providing by the network administrator of the network servers 101-103, or alternatively, be automatically acquired by a backup web page acquisition unit 3212.

The backup web page acquisition unit 3212 can acquire the web page content of the network servers 101-103 by means of network spider, for example. In addition, in order to acquire the web page content of the network servers 101-103 more securely, the web page tamper-proof device 202 can further comprise a management network interface (which is not illustrated in the figures) through which the backup web page acquisition unit 3212 may be connected with the corresponding internal interface of the network servers 101-103 so as to acquire the web page content in the manner of network spider and so on. In other words, the backup web page content can be acquired from an internal network which is isolated from the external network and comprises the web page tamper-proof device 202 and the network servers 101-103. In this case, the backup content of web page stored in the backup web page storage 3206 can be constructed securely and conveniently.

When the web page content comparison unit 3205 determines that the regenerated web page content has been tampered, it sends a message regarding the web page has been tampered to a network server take-over unit 3211 which in turn sends a network server take-over signal to the network data packet processing unit 3203 upon receipt of such message, and after receiving the network server take-over signal, the network data packet processing unit 3203 stops forwarding the request for the content of web page from the external network user to the network servers 101-103, but instead, forwards the request to the network server take-over unit 3211 for processing. Therefore, the connections between the external network user and the network servers are cut off and the network server take-over unit 3211 serves the subsequent requests for web page content, where the network server take-over unit 3211 may function as the network servers 101-103 and serves the requests for web page content by using the backup content of web pages stored in the backup web page storage 3206. It should be noted that, at this time, the network data packet processing unit 3203 does not send the web page content returned by the network server take-over unit 3211 to the web page regenerating unit 3204 for further processing, but instead, directly feeds it back to the external network user via the external network interface 3201. This can be achieved by arranging different switches in the network data packet processing unit 3203 and operating these switches based on the network server take-over signal.

The web page tamper-proof device 202 may further comprises a cellphone message alarm 3209 and an email alarm 3210 for respectively sending a message and an email to inform the related administrators that the content of web pages of the network servers has been tampered when the web page content comparison unit 3205 determines that the regenerated content of web page has been tampered and issues a message regarding that. By doing that, the administrators of the network servers may get this message as early as possible, find out the reason for the content of web pages of the network servers 101-103 being tampered immediately, and take measures to recover so as to maintain the stability of the network servers 101-103.

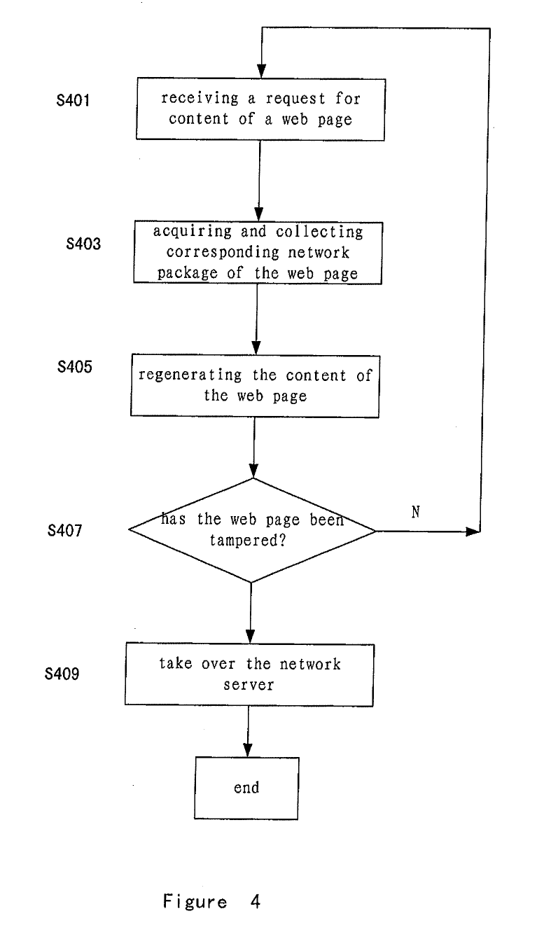

FIG. 4 shows the flowchart of a web page tamper-proof method 400 according to an embodiment of the present invention. The method can be performed typically in a web page tamper-proof device 202 as shown in FIG. 3. Firstly, in step S401, a request for content of a web page of one of the network servers 101-103 (network server 101, for example) from an external network user is received. Then, in step S403, network data packets returned from the network server 101 replying to the request for content of the web page received in step S401 are acquired. Generally speaking, for each request for content of the web page, there are more than one data packets corresponding to the request, so in step S403, network data packets responding to the request for content of the web page received in step S401 are further to be collected. Step 401 and step 403 are usually performed in the network data packet processing unit 3203.

In step S405, the web page regenerating unit 3204 regenerates the web page content from the network data packets acquired and collected in step S403. As mentioned above, the regenerating process generally comprises IP decoding, TCP decoding and HTTP identification, etc. In step S407, a web page content comparison unit 3205 acquires identifiers of the network server, such as IP address and port number of the network server 101 based on the web page content regenerated in step S405, retrieves corresponding backup web page content stored in advance in the web page tamper-proof device 202 based on the identifiers, and then compares the regenerated web page content with the backup web page content to determine whether the regenerated web page content regenerated in step S405 has been tampered. In step S407, many methods can be used to determine whether the web page content has been tampered. For instance, the Hash values of the regenerated web page content and the backup web page content can be calculated respectively. If they are different, it can be determined that the regenerated web page content has been tampered. If it is determined in step S407 that the web page content has not been tampered, the method returns to step S401 so as to continue monitoring new requests for web page content. On the contrary, if it is determined in step S407 that the web page content has been tampered, the method proceeds to step S409 so as to take over the network server 101 to provide service for the request for web page content from the network user. At this time, the network server 101 no longer receives any requests from the external network user, so the system administrator can bring the network server 101 offline, analyze the scene of the network server 101 so as to determine the system vulnerabilities existing in the network server 101 and recover the tampered web page content. Of course, in step S409, a message regarding the content of web page of the network server 101 has been tampered can further be sent to the network administrator in the form of cellphone message or email, etc. when the network server 101 is taken over.

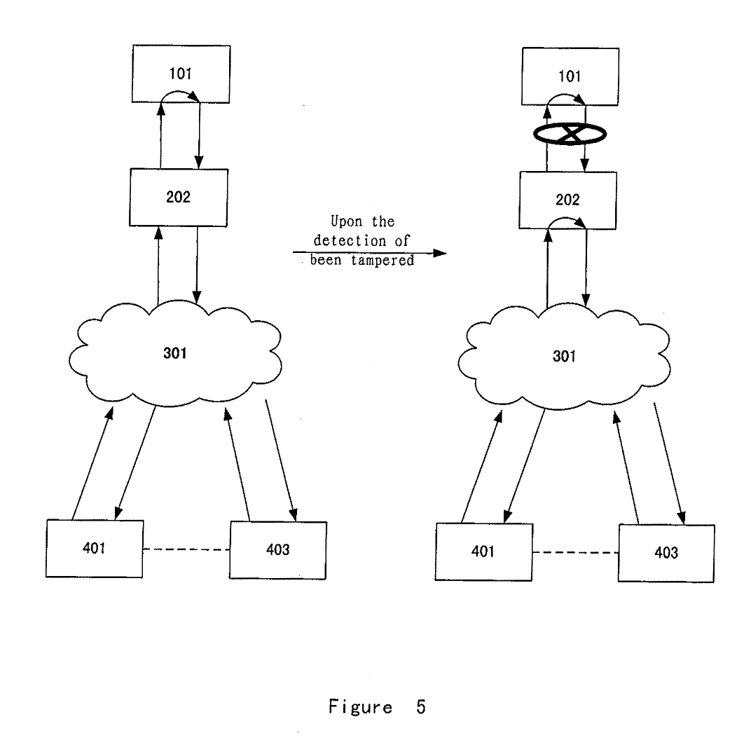

FIG. 5 shows a specific operation state of the web page tamper-proof system 200 according to an embodiment of the present invention. The figure on the left shows the system 200 in a normal operation state, where the web page tamper-proof device 202 only detects the web page content provided by the network server 101, but it is still the network server 101 that provides web page content service. The figure on the right shows that all connections between the external network user and the network server 101 are completely cut off upon detection that the web page content of the network server 101 has been tampered, and the web page tamper-proof device 202 provides web page content service instead of the network server. In this case, on the one hand, for the network user, he will not receive the web page content which has been tampered and the operation of browsing through the web page content will not be interrupted either. On the other hand, for the network server 101, offline operation can be conveniently performed without the worry of interrupting the request for web page content from the network user.

Apparently, after the web page content of the network server 101 has been recovered and the system vulnerabilities have been patched, the network server 101 may be reconnected with the web page tamper-proof device 202 to provide web page content service for the network user. Meanwhile, the method as shown in FIG. 4 is performed again.

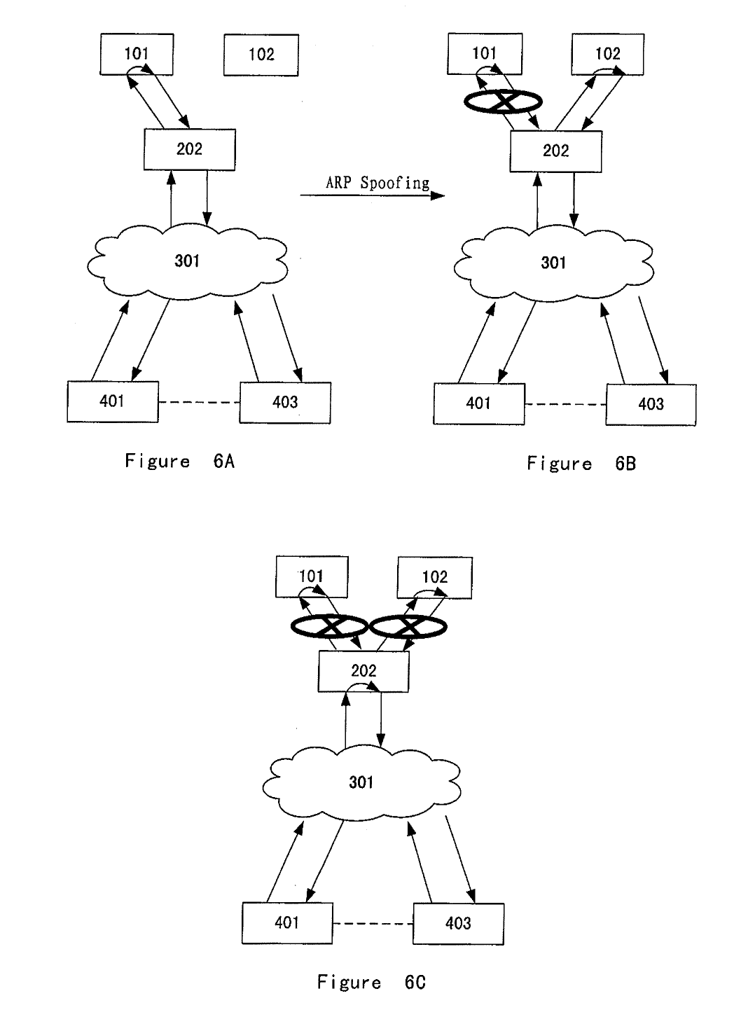

FIGS. 6A-6C show further specific operations of the web page tamper-proof system 200 coping with tampering based on ARP spoofing according to an embodiment of the present invention.

FIG. 6A shows the flow of processing the request for web page content in a normal state, wherein the network server 101 provides normal web page content service and requests for web page content from clients 401-403 are all forwarded to the network server 101 by the web page tamper-proof device 202. The network server 102 will not reply to the requests for web page content from the clients 401-403.

FIG. 6B shows the situation where the network server 102 is made to reply to the requests for web page content which should have been sent to the network server 101 based on ARP spoofing after the network server 102 is cracked by the hacker. As a result, the network server 102 hijacks the network server 101 based on ARP spoofing so that it can reply with different web page contents, and the connection between the network server 101 and the clients is cut off. Viewing from the perspective of the clients 401-403 at this time, the web page content of the network server 101 has been tampered.

FIG. 6C shows the processing flow of the web page tamper-proof system 200 for preventing ARP spoofing based tampering according to an embodiment of the present invention. When the network server 102 hijacks the network server 101 based on ARP spoofing and feeds content back to the clients 401-403 in the name of the network server 101, the web page tamper-proof device 202 detects that the returned web page content is different from that of the original network server 101 stored in advance in the device 202, based on which it determines that the web page content of the network server 101 has been tampered. Then the device 202 will not forward the request for web page content of the network server 101, but instead, reply to the request by itself. Therefore, even if the network server 102 hijacks the network server 101, it cannot feed the tampered web page content back to the clients 401-403. That is, the connections to the network servers 101 and 102 are both cut off. For the clients, they will not receive the web page content which has been tampered and the operation of browsing through the web page content will not be interrupted either.

It should be noted that in the web page tamper-proof device according to the present invention, the components therein are logically divided in light of the functions to be achieved. However, the present invention is limited by this and the components of the web page tamper-proof device can be redivided or recombined upon requirement, for instance, some components can be combined as an individual component or some components can be further divided into more sub-components.

The embodiments of the present invention can be implemented by hardware or by software modules operated on one or more processors, or by the combination of them. One skilled in the art should understand that microprocessors or digital signal processors (DSP) can be used to implement part or all of the functions of some or all of the components of the web page tamper-proof device according to an embodiment of the present invention in practice. The present invention can further be embodied as device or programs (for example, computer programs and computer program products) for executing part or all of the method described herein. Such programs carrying out the present invention can be stored in a computer-readable medium, or have the form of one or more signals. Such signals can be downloaded from Internet websites or be provided by a carrier signal or be provided in any other forms.

It should be noted that the above embodiments illustrate rather than limit the invention, and that those skilled in the art will be able to design alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The present invention can be achieved by means of hardware comprising several different elements and by means of an appropriately programmed computer. In the unit claims listing several means, several of these means can be embodied by one and the same item of hardware. The use of ordinal words such as first, second and third does not represent any order, but instead, they can be understood as titles.

What is claimed is:

1. A web page tamper-proof method, comprising steps of:
receiving a request for content of a web page of a network server from an external network user;
acquiring network data packets returned by said network server in response to the request for content of the web page from the external network user;
regenerating the content of the web page based on the acquired network data packets;
comparing the regenerated content of the web page with a previous backup content of the web page corresponding to the regenerated content of the web page, to determine whether the regenerated content of the web page has been tampered; and
if the regenerarted content of the web page has been tampered, then returning the backup content of the web page back to the external network user.

2. The method according to claim 1, wherein if the regenerated content of the web page has been tampered, the method further comprises the step of:
cutting off the connection between the external network and the network server.

3. The method according to claim 1, wherein the step of acquiring the network data packets returned by the network server further comprises:
collecting a plurality of network data packets corresponding to the request for the content of the web page.

4. The method according to claim 1, wherein the step of determining whether the regenerated content of the web page has been tampered further comprises:
calculating the Hash values of the regenerated content of the web page and the backup content of the web page respectively, and if they are different, then it can be determined that the regenerated content of the web page has been tampered.

5. The method according to claim 1, wherein if the regenerated content of the web page has been tampered, the method further comprises the step of:
sending cellphone message or email to inform the network administrator that the content of the web page of the network server has been tampered.

6. A computer program product, comprising instructions for carrying out the method steps according to claim 1 when loaded to and operated on a computer.

7. A recording medium which stores instructions for carrying out the method steps according to claim 1 when loaded to and operated on a computer.

8. A web page tamper-proof device, comprising:
an external network interface, connected with an external network for receiving a request for content of a web page of a network server from an external network user and returning the requested content of the web page back to the external network user;
an internal network interface, connected with the network server for forwarding the request for the content of the web page from the external network user to the networker server and acquiring the network data packets returned by said network server in response to the request for the content of the web page;
a network data packet processing unit, configured to intercept the network data packets returned by said network server in response to the request for the content of the web page;
a web page regenerating unit, configured to receive the network data packets intercepted by the network data packet processing unit and regenerate the content of the web page from the network data packets;
a web page content comparison unit, configured to compare the content of the web page regenerated by the web page regenerating unit with a backup content of the web page corresponding to the regenerated content of the web page, to determine whether the regenerated content of the web page has been tampered, and when the regenerated content of the web page is determined to have been tampered, send a message regarding the web page has been tampered to a network server take-over unit; and
the network server take-over unit, configured to return the backup content of the web page corresponding to the regenerated content of the web page back to the external network user upon receipt of the message.

9. The device according to claim 8, wherein the network server take-over unit is configured to send a network server take-over signal to the network data packet processing unit upon receipt of the message regarding the web page has been tampered, and after receiving the network server take-over signal, the network data packet processing means is configured to stop forwarding the request for the content of the web page from the network user to the network server.

10. The device according to claim 8, wherein the network data packet processing unit further comprises a storage unit for collecting a plurality of network data packets corresponding to the request for the content of the web page.

11. The device according to claim 8, further comprising:
a backup web page storage for storing the previous backup content of the web page corresponding to the content of the web page of the network server,
wherein, the web page content comparison unit and the network server take-over unit are configured to retrieve from the backup web page storage the content of the web page corresponding to the regenerated content of the web page.

12. The device according to claim 8, wherein the web page content comparison unit is configured to calculate the Hash values of the recovered content of the web page and the backup content of the web page respectively, and when these two Hash values are different, it can be determined that the regenerated content of the web page has been tampered:

13. The device according to claim 8, further comprising:
a cellphone message or an email alarm for sending a message and an email to inform the network administrator that the content of the web page of the network server has been tampered upon receipt of a message regarding the web page has been tampered.

14. A web page tamper-proof system, comprising:
one or more network servers, which are provided with content of web pages;
an external network, wherein the user thereof sends a request for content of a web page to said one or more network servers for acquiring the content of the web page; and
a web page tamper-proof device according to any one of claims 6-11, connected between the one or more network servers and the external network, configured to return the content of the web page by itself when the content of the web page returned by the one or more network server has been tampered.
